(19) United States
(12) Patent Application Publication
(10) Pub. No.: US 2022/0288749 A1
(43) Pub. Date: Sep. 15, 2022

(54) EXPANDABLE FIXTURE

(71) Applicant: YUN KUAN ENTERPRISE CO.,LTD., Tongluo Township (TW)

(72) Inventor: WEN-CHE CHEN, Tongluo Township (TW)

(21) Appl. No.: 17/665,584

(22) Filed: Feb. 6, 2022

(51) Int. Cl. B25B 5/06; B25B 5/00; B25B 5/16

(52) U.S. Cl. CPC B25B 5/068; B25B 5/006; B25B 5/163; B25B 5/166

(57) ABSTRACT

An expandable fixture contains: a first body, a second body, and an actuation rod. The first body includes a first clamp and a grip. The second body includes a connection structure, and the second body includes a second clamp. The first body further includes a drive mechanism configured to pull the actuation rod to drive the first clamp and the second clamp to clamp, a press extension configured to control the drive mechanism, and a first positioning structure vertically corresponding to the actuation rod. The second body includes a second positioning structure rotatably connected on a peripheral side thereof, and each of the first positioning structure and the second positioning structure is a respective one of two T-shaped posts slidably mounted on a respective one of two T-shaped slide rails of a work table.

### FIELD OF THE INVENTION

The present invention relates to an expandable fixture which is capable of adjusting the workpiece to a desired position easily.

### BACKGROUND OF THE INVENTION

A conventional fixture is applied to clamp a workpiece, wherein when connecting two workpieces, a single workpiece is fixed in a welding manner, a screwing manner, or a riveting manner. Then, another workpiece is fixed on a work table by a woodworking clamp formed in a gun shape. However, the woodworking clamp is merely used to fix the workpiece adjacent to a peripheral side of the work table.

The present invention has arisen to mitigate and/or obviate the afore-described disadvantages.

### SUMMARY OF THE INVENTION

The primary aspect of the present invention is to provide an expandable fixture which contains the first positioning structure and the second positioning structure fixed on the T-shaped slide rail or the fixing orifice of the work table after removing the first body and the second body, and the first body and the second body are configured to adjust the workpiece to a desired position of the work table easily.

To obtain the above mentioned aspect, an expandable fixture provided by the present invention contains: a first body, a second body, and an actuation rod.

The first body includes a first clamp and a grip, and the actuation rod is movably accommodated and moves in the first body.

The second body includes a connection structure removably connected with an end of the actuation rod, and the second body includes a second clamp defined on a surface thereof corresponding to the first clamp.

The first body further includes a drive mechanism configured to pull the actuation rod to drive the first clamp and the second clamp to clamp, a press extension fixed on a bottom of the first body and configured to control the drive mechanism, and a first positioning structure rotatably connected on a peripheral side of the first body and vertically corresponding to the actuation rod;

The second body includes a second positioning structure rotatably connected on a peripheral side thereof, and each of the first positioning structure and the second positioning structure is a respective one of two T-shaped posts slidably mounted on a respective one of two T-shaped slide rails of a work table.

Preferably, the second body further includes a first abutting plane forced perpendicular to the second positioning structure.

Preferably, the expandable fixture further contains a fitting member, wherein the fitting member includes a receiving orifice defined on a first end thereof and configured to fit with the actuation rod, and the fitting member includes a second abutting plane formed on a second end thereof.

Preferably, the first positioning structure has a first threaded peg extending from an end thereof, and the second positioning structure has a second peg extending from an end thereof, wherein the first body further includes a first screw orifice defined on the peripheral side thereof and rotatably connected with the first threaded peg, and the second body further includes a second screw orifice defined on the peripheral side thereof and rotatably connected with the second threaded peg.

Preferably, the second body includes a second locking orifice formed below the second clamp, and the second threaded peg of the second positioning structure s alternatively locked with the second locking orifice.

In another embodiment, an expandable fixture contains: a first body, a second body, and an actuation rod.

The first body includes a first clamp and a grip, and the actuation rod is movably accommodated and moves in the first body.

The second body includes a connection structure removably connected with an end of the actuation rod, and the second body includes a second clamp defined on a surface thereof corresponding to the first clamp.

The first body further includes a drive mechanism configured to pull the actuation rod to drive the first clamp and the second clamp to clamp, a press extension fixed on a bottom of the first body and configured to control the drive mechanism, and a first positioning structure rotatably connected on a peripheral side of the first body and vertically corresponding to the actuation rod.

The second body includes a second positioning structure rotatably connected on a peripheral side thereof, and the first positioning structure and the second positioning structure are inserted into two of multiple fixing orifices of the work table.

Preferably, the expandable fixture further contains: a fixer including a threaded orifice, wherein the second body includes a second locking orifice formed below the second clamp, the second positioning structure includes a first threaded peg extending from a first end thereof, and the second positioning structure includes a second threaded peg extending from a second end thereof, wherein the first threaded peg is alternatively locked with the second locking orifice, and the second threaded peg is locked with the threaded orifice of the fixer.

### BRIEF DESCRIPTION OF THE DRAWINGS

FIG. 1 is a perspective view showing the exploded components of an expandable fixture according to a first embodiment of the present invention.

FIG. 2 is a perspective view showing the application of the expandable fixture according to the first embodiment of the present invention.

FIG. 3 is a side plan view showing the application of the expandable fixture according to the first embodiment of the present invention.

FIG. 4 is a perspective view showing the exploded components of an expandable fixture according to a second embodiment of the present invention.

FIG. 5 is a perspective view showing the application of the expandable fixture according to the second embodiment of the present invention.

FIG. 6 is a perspective view showing the exploded components of an expandable fixture according to a third embodiment of the present invention.

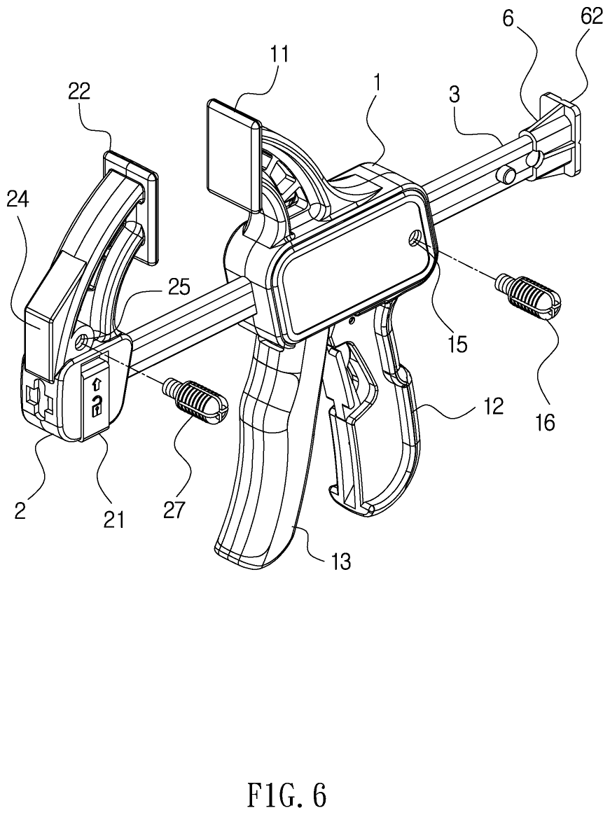

FIG. 7 is a perspective view showing the application of an expandable fixture according to the third embodiment of the present invention.

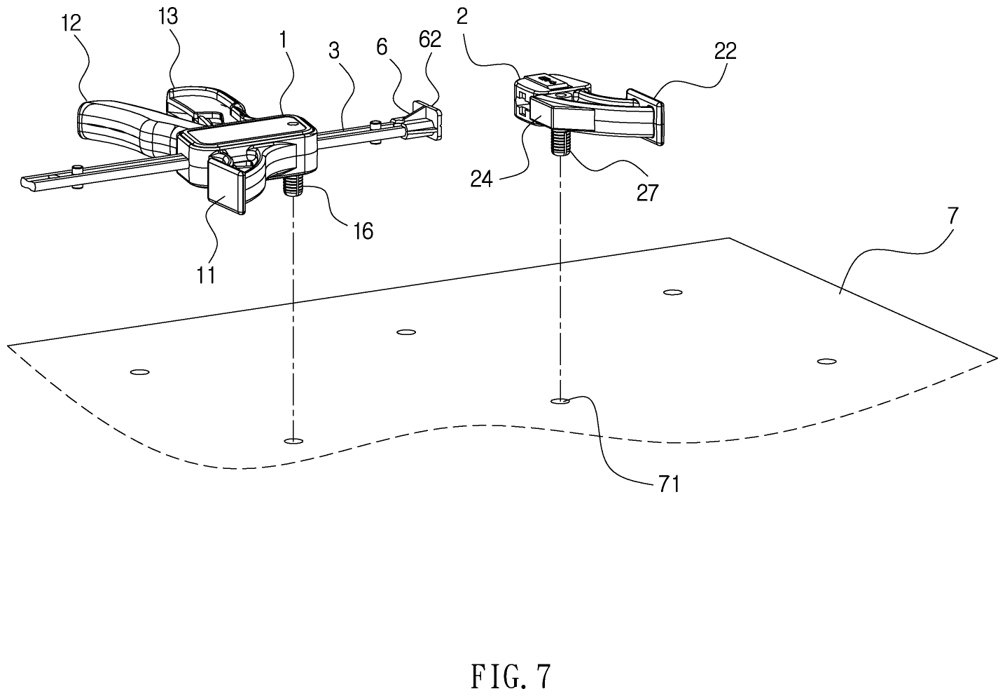

FIG. 8 is a perspective view showing the exploded components of an expandable fixture according to a fourth embodiment of the present invention.

FIG. 9 is a side plan view showing the application of the expandable fixture according to the fourth embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

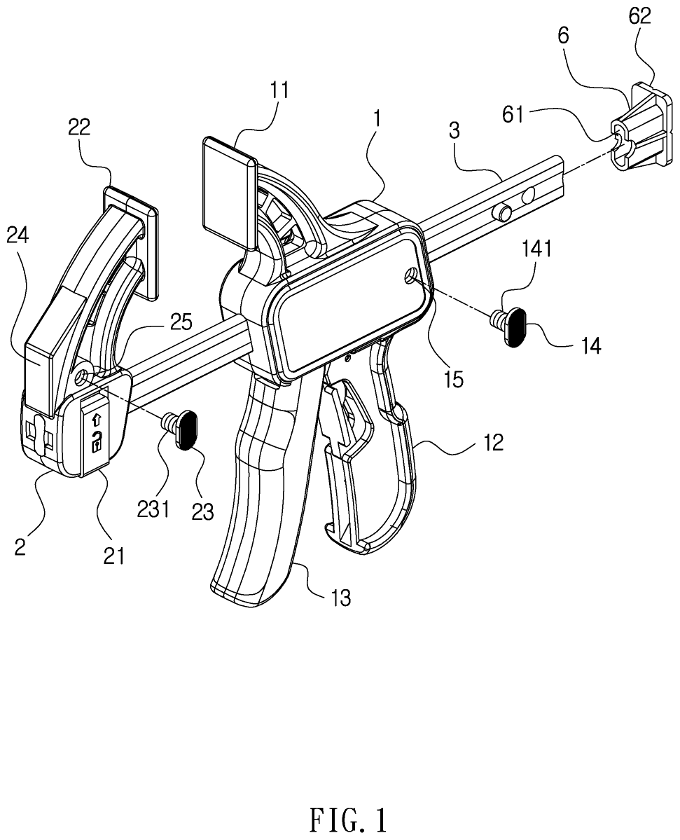

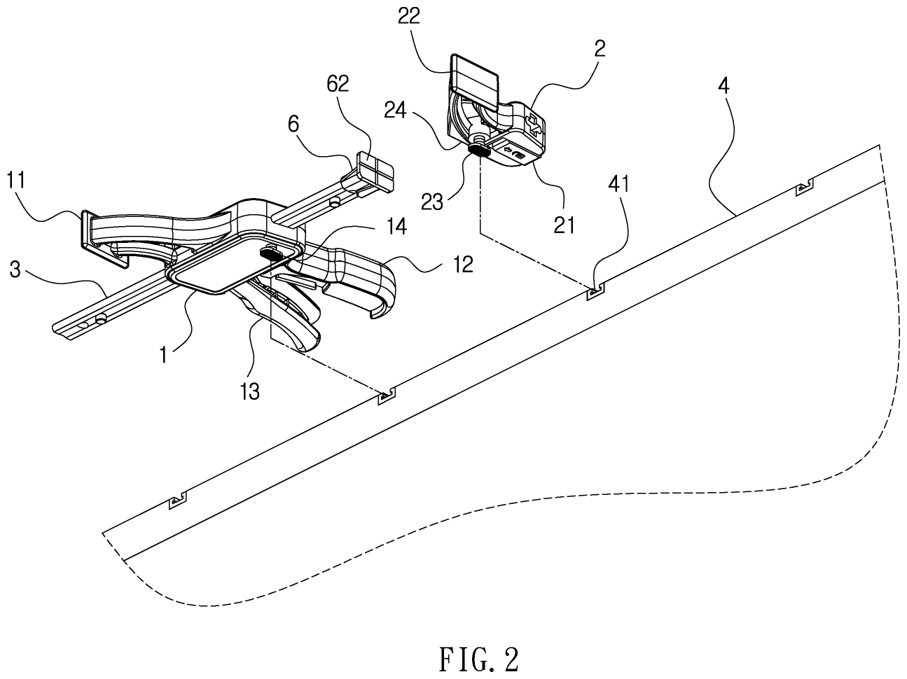

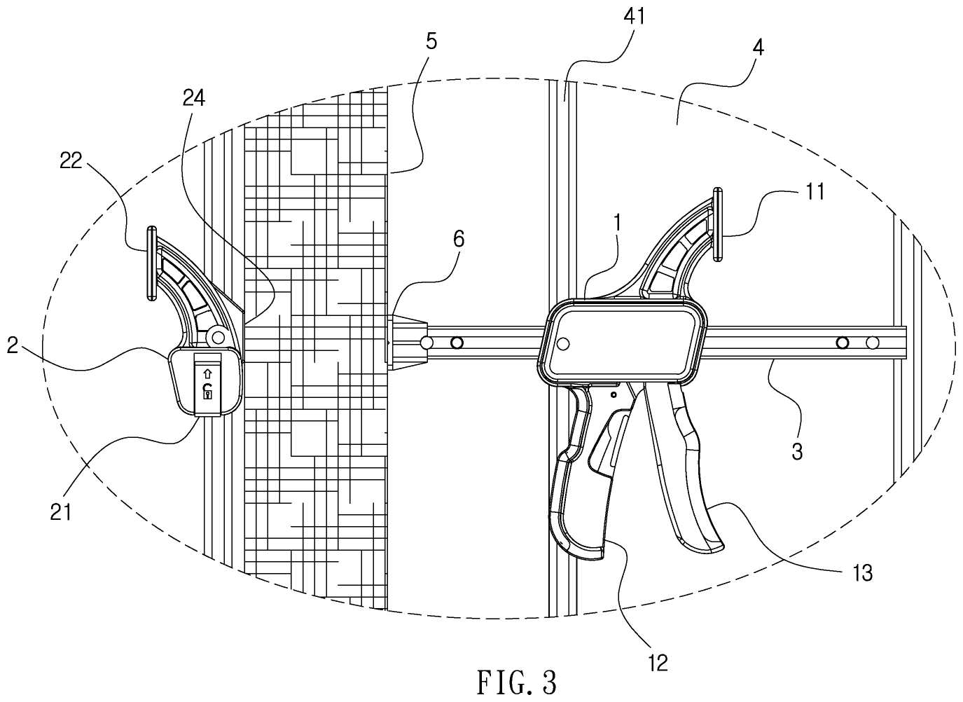

With reference to FIGS. 1-3, an expandable fixture according to a first embodiment of the present invention comprises: a first body 1, a second body 2, and an actuation rod 3.

The first body 1 includes a first clamp 11 and a grip 12, and the actuation rod 3 is movably accommodated and moves in the first body 1.

The second body 2 includes a connection structure 21 removably connected with an end of the actuation rod 3, and the second body 2 includes a second clamp 22 defined on a surface thereof corresponding to the first clamp 11.

The first body 1 further includes a drive mechanism (because the drive mechanism is a well-known art, further remarks are omitted) configured to pull the actuation rod 3 to drive the first clamp 11 and the second clamp 22 to clamp, a press extension 13 fixed on a bottom of the first body 1 and configured to control the drive mechanism, and a first positioning structure 14 rotatably connected on a peripheral side of the first body 1 and vertically corresponding to the actuation rod 3.

The second body 2 includes a second positioning structure 23 rotatably connected on a peripheral side thereof, wherein each of the first positioning structure 14 and the second positioning structure 23 is a respective one of two T-shaped posts slidably mounted on a respective one of two T-shaped slide rails 41 of a work table 4.

Thereby, the second body 2 is detachable from the actuation rod 3, wherein the first positioning structure 14 is fixed on a first T-shaped slide rail 41, and the second positioning structure 23 is mounted on a second T-shaped slide rail 41 parallel to the first T-shaped slide rail 41, and a workpiece 5 is fixed between a distal end of the actuation rod 3 and the second body 2 so that the actuation rod 3 is controlled to move to the second body 2 by pressing the press extension 13, and the workpiece 5 is positioned between the actuation rod 3 and the second body 2.

The second body 2 further includes a first abutting plane 24 forced perpendicular to the second positioning structure 23, such that the second body 2 does not deflect after being pushed by the actuation rod 3.

The expandable fixture further comprises a fitting member 6, wherein the fitting member 6 includes a receiving orifice 61 defined on a first end thereof and configured to fit with the actuation rod 3, and the fitting member 6 includes a second abutting plane 62 formed on a second end thereof, such that the fitting member 6 facilitates a forced area of the actuation rod 3 with respect to the workpiece, thus avoiding a deformation and a damage of the workpiece.

The first positioning structure 14 has a first threaded peg 141 extending from an end thereof, and the second positioning structure 23 has a second peg 231 extending from an end thereof, wherein the first body 1 further includes a first screw orifice 15 defined on the peripheral side thereof and rotatably connected with the first threaded peg 141, and the second body 2 further includes a second screw orifice 25 defined on the peripheral side thereof and rotatably connected with the second threaded peg 231, such that the first positioning structure 14 is adjustably locked on the first body 1 in a depth, and the second positioning structure 23 is adjustably locked on the second body 2 in another depth, thus mating with a depth of the T-shaped slide rail 41 of the work table 4.

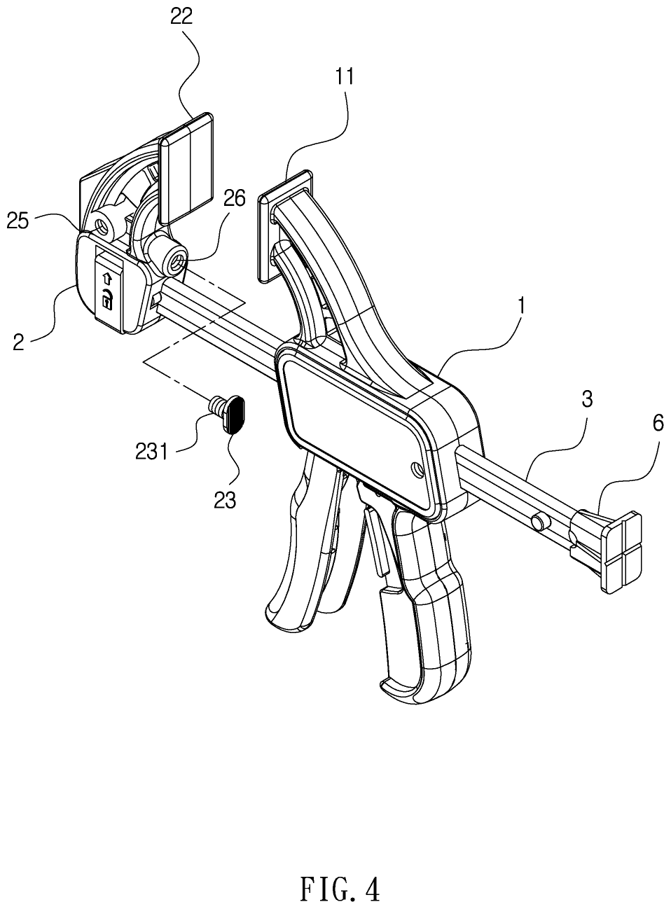

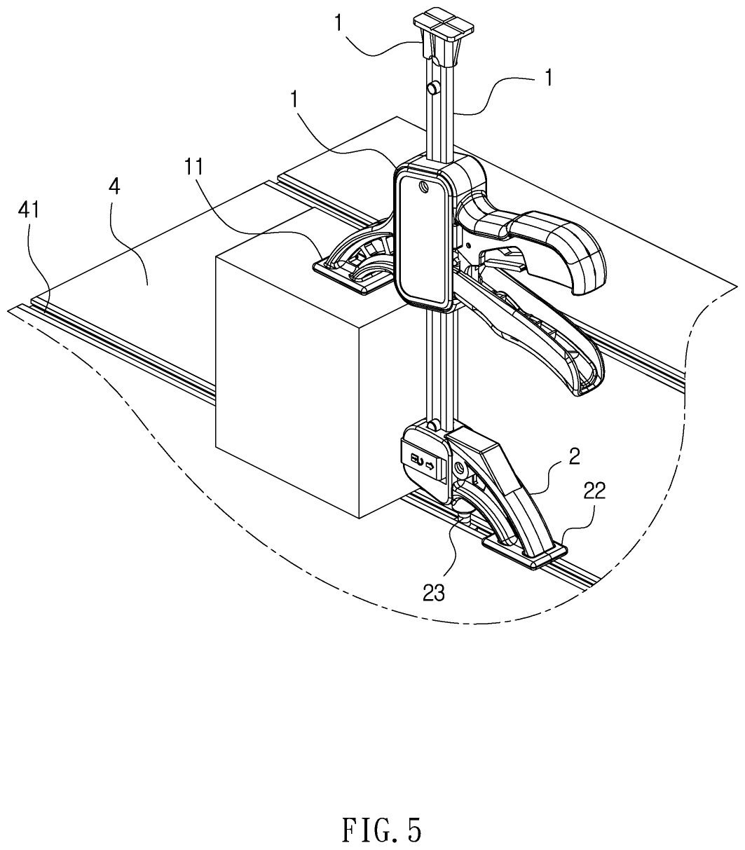

Referring to FIGS. 4-5, in a second embodiment, the second body 2 includes a second locking orifice 26 formed below the second clamp 22, wherein the second threaded peg 231 of the second positioning structure 23 is alternatively locked with the second locking orifice 26, such that when the second positioning structure 23 is slidably engaged on the T-shaped slide rail 41, the second clamp 22 clamps the work table 4, and the actuation rod 3 is accommodated in the second body 2, thus clamping the workpiece perpendicular to the work table 4.

As shown in FIGS. in a third embodiment, the first positioning structure 16 and the second positioning structure 27 are inserted into two of multiple fixing orifices 71 of the work table 7, such that the second body 2 is detachable from the actuation rod 3, and the workpiece 5 is defined between the distal end of the actuation rod 3 and the second body 2, wherein the actuation rod 3 is driven by the press extension 13 to move to the second body 2 after pressing the press extension 13, and the workpiece 5 is positioned between the actuation rod 3 and the second body 2.

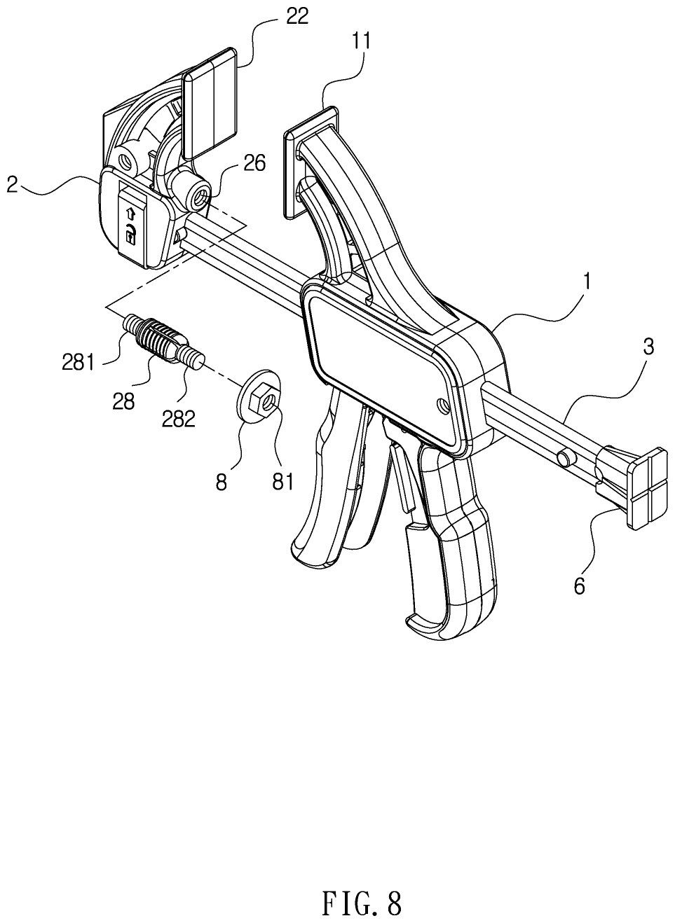

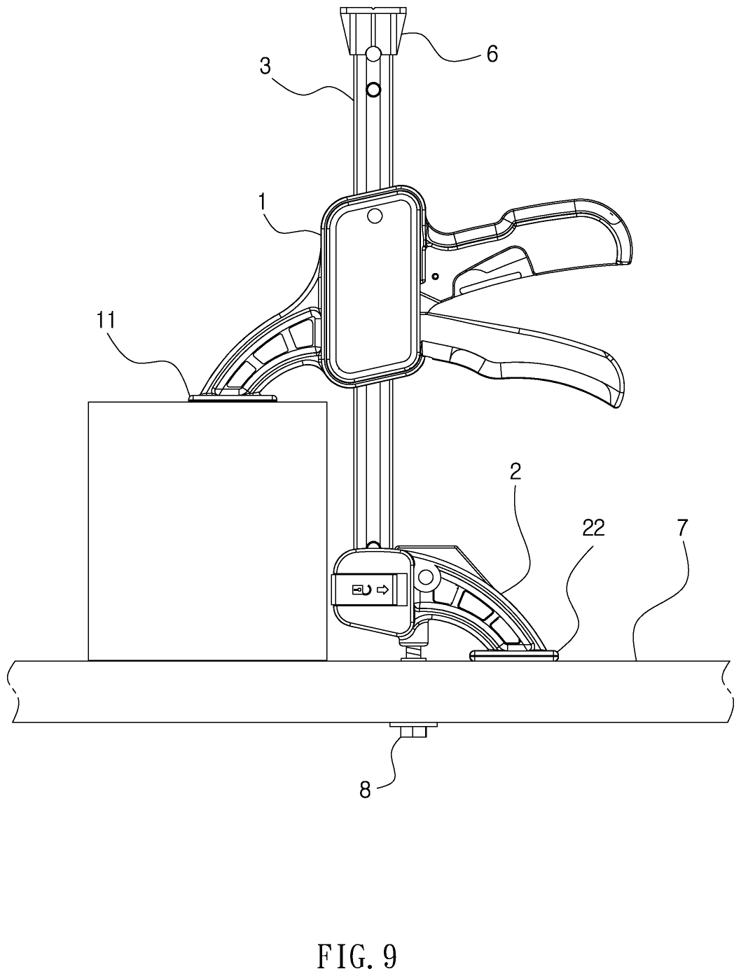

As illustrated in FIGS. 8 and 9, in a fourth embodiment, the expandable fixture comprises a fixer 8 including a threaded orifice 81, the second positioning structure 28 includes a first threaded peg 281 extending from a first end thereof, and the second positioning structure 28 includes a second threaded peg 282 extending from a second end thereof, wherein the first threaded peg 281 is alternatively locked with the second locking orifice 26, and the second threaded peg 282 is locked with the threaded orifice 81 of the fixer 8, such that when the second positioning structure 28 is inserted into one of the multiple fixing orifice 71 of the work table 7, the fixer 8 is mounted on a bottom of the work table 7, and the second body 2 is disposed on a top of the work table. Thereafter, the first body 1 clamps the workpiece vertically with respect to the work table 7 by ways of the actuation rod 3 and the second body 2.

Thereby, the first positioning structure and the second positioning structure are fixed on the T-shaped slide rail or the fixing orifice of the work table after removing the first body and the second body, and the first body and the second body are configured to adjust the workpiece to desired positions of the work table easily.

While various embodiments in accordance with the present invention have been shown and described, it is clear to those skilled in the art that further embodiments may be made without departing from the scope of the present invention.

What is claimed is:

1. An expandable fixture comprising: a first body, a second body, and an actuation rod;
wherein the first body includes a first clamp and a grip, and the actuation rod is movably accommodated and moves in the first body;
wherein the second body includes a connection structure removably connected with an end of the actuation rod, and the second body includes a second clamp defined on a surface thereof corresponding to the first clamp;
wherein the first body further includes a drive mechanism configured to pull the actuation rod to drive the first clamp and the second clamp to clamp, a press extension fixed on a bottom of the first body and configured to control the drive mechanism, and a first positioning structure rotatably connected on a peripheral side of the first body and vertically corresponding to the actuation rod;
wherein the second body includes a second positioning structure rotatably connected on a peripheral side thereof, and each of the first positioning structure and the second positioning structure is a respective one of two T-shaped posts slidably mounted on a respective one of two T-shaped slide rails of a work table.

2. The expandable fixture as claimed in claim 1, wherein the second body further includes a first abutting plane forced perpendicular to the second positioning structure.

3. The expandable fixture as claimed in claim 1 further comprising a fitting member, wherein the fitting member includes a receiving orifice defined on a first end thereof and configured to fit with the actuation rod, and the fitting member includes a second abutting plane formed on a second end thereof.

4. The expandable fixture as claimed in claim 1, wherein the first positioning structure has a first threaded peg extending from an end thereof, and the second positioning structure has a second peg extending from an end thereof, wherein the first body further includes a first screw orifice defined on the peripheral side thereof and rotatably connected with the first threaded peg, and the second body further includes a second screw orifice defined on the peripheral side thereof and rotatably connected with the second threaded peg.

5. The expandable fixture as claimed in claim 4, wherein the second body includes a second locking orifice formed below the second clamp, and the second threaded peg of the second positioning structure s alternatively locked with the second locking orifice.

6. An expandable fixture comprising: a first body, a second body, and an actuation rod;
wherein the first body includes a first clamp and a grip, and the actuation rod is movably accommodated and moves in the first body;
wherein the second body includes a connection structure removably connected with an end of the actuation rod, and the second body includes a second clamp defined on a surface thereof corresponding to the first clamp;
wherein the first body further includes a drive mechanism configured to pull the actuation rod to drive the first clamp and the second clamp to clamp, a press extension fixed on a bottom of the first body and configured to control the drive mechanism, and a first positioning structure rotatably connected on a peripheral side of the first body and vertically corresponding to the actuation rod;
wherein the second body includes a second positioning structure rotatably connected on a peripheral side thereof, and the first positioning structure and the second positioning structure are inserted into two of multiple fixing orifices of the work table.

7. The expandable fixture as claimed in claim 1 further comprising a fixer including a threaded orifice, wherein the second body includes a second locking orifice formed below the second clamp, the second positioning structure includes a first threaded peg extending from a first end thereof, and the second positioning structure includes a second threaded peg extending from a second end thereof, wherein the first threaded peg is alternatively locked with the second locking orifice, and the second threaded peg is locked with the threaded orifice of the fixer.
